(19) United States
(12) Patent Application Publication
(10) Pub. No.: US 2019/0147758 A1
(43) Pub. Date: May 16, 2019

(54) SYSTEM AND METHOD TO TEACH AMERICAN SIGN LANGUAGE

(71) Applicant: Corey Lynn Andona, Murphys, CA (US)

(72) Inventor: Corey Lynn Andona, Murphys, CA (US)

(21) Appl. No.: 15/810,074

(22) Filed: Nov. 12, 2017

(51) Int. Cl. G09B 5/02; G09B 7/02; G09B 19/00

(52) U.S. Cl. CPC G09B 5/02; G09B 19/0007; G09B 7/02

(57) ABSTRACT

A system to learn American Sign Language that includes: a plurality of portals accessible through a software application, wherein said plurality of portals enable a user to engage in interactive learning experiences; a first level of engagement for each portal; and a second level of engagement for each portal, where each second level provides an interactive platform for the use of the system. The plurality of portals includes a lesson portal, a dictionary portal, a gaming portal, a history portal, a news portal, a contact portal and a support portal. The lesson portal includes a vocabulary option, tests and quizzes and a plurality of American Sign Language lessons. Preferably, the plurality of American Sign Language lessons including a Phase 1 level and a Phase 2 level. Users may complete tests and quizzes after completion of lessons to assess their learning progress.

### BACKGROUND OF THE INVENTION

### Field of Invention

The present invention relates to a system that provides an effective means to teach a user American Sign Language.

### Description of Related Art

American Sign Language is a well-known art form that has been used by individuals who are hearing impaired to communicate. This communication technique has been a well-established means of communication for several years. The sign language allows deaf individuals to communicate with other individuals who are familiar with the sign language in their day-to-day lives. Further many public announcements, speeches or broadcasts include or utilize American Sign Language to communicate the audio that may be associated with the presentation. American Sign Language is widely used and is considered the protocol for communications between and among deaf individuals. However, there are limited means for individuals to learn American Sign Language. Some schools are set up for this purpose and courses are available for individuals to learn this language. However, a concise interactive platform would be desirable to teach and learn American Sign Language.

### SUMMARY OF THE INVENTION

The present invention relates to a system to learn American Sign Language that includes: a plurality of portals accessible through a software application, wherein said plurality of portals enable a user to engage in interactive learning experiences; a first level of engagement for each portal; and a second level of engagement for each portal, where each second level provides an interactive platform for the use of the system. The plurality of portals includes a lesson portal, a dictionary portal, a gaming portal, a history portal, a news portal, a contact portal and a support portal. The lesson portal includes a vocabulary option, tests and quizzes and a plurality of American Sign Language lessons. Preferably, the plurality of American Sign Language lessons including a Phase 1 level and a Phase 2 level. Users may complete tests and quizzes after completion of lessons to assess their learning progress.

### BRIEF DESCRIPTION OF DRAWINGS

FIG. 1 depicts a protocol for a system according to the present invention.

FIG. 2 depicts a series of lessons that are associated with the system according to the present invention.

### DETAILED DESCRIPTION

The present invention relates to a system and method to learn American Sign Language that includes a plurality of portals that are accessible through a software application. The plurality of portals enable a user to engage in an interactive learning experience associated with American Sign Language. The plurality of portals is accessible through a software application. The portals include lessons, a dictionary, gaming, history, news, contact apps and other aspects to provide a totally engaging experience. Each portal has a first level of engagement and a second level of engagement so user can select data or information on various topics. The user may also select various lessons associated with learning American Sign Language.

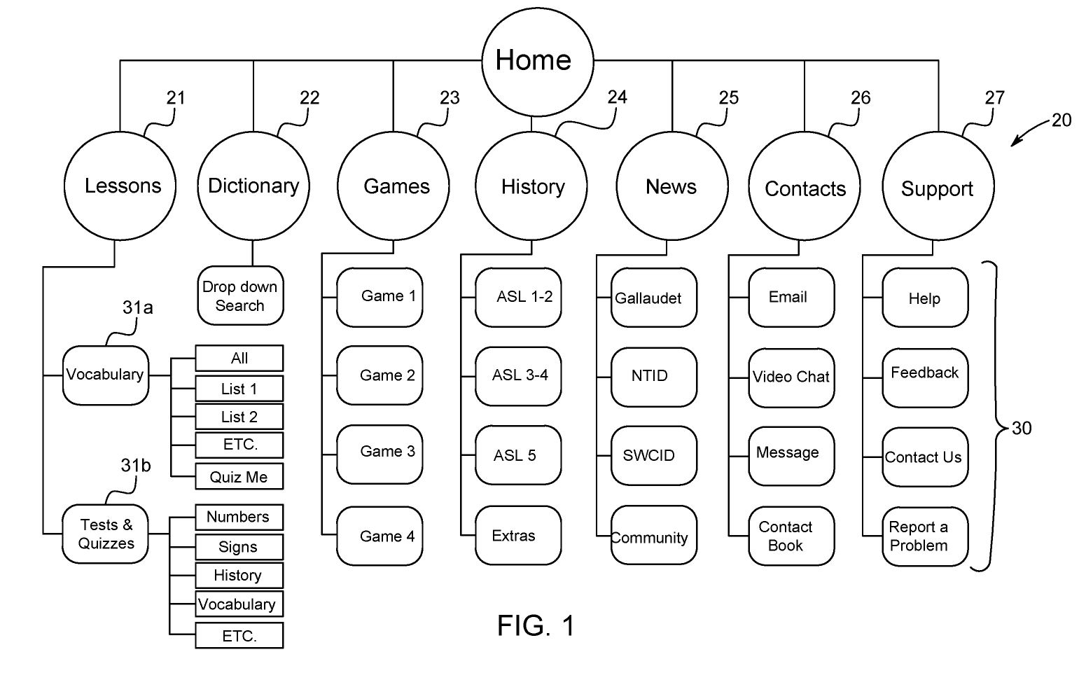

In reference to FIG. 1, an overview of a home portal page according to the present invention is depicted. This home portal page includes a plurality of portals 20 as shown in FIG. 1. The portals include lessons 21, dictionary 22, gaming 23, history 24, news 25, contacts 26 and support 27. A first level 20 and a second level of engagement 30 is provided for each portal 20. The first level of engagement enable a user to access the portal and then the second level allows the individual to select various aspects within the selected portal.

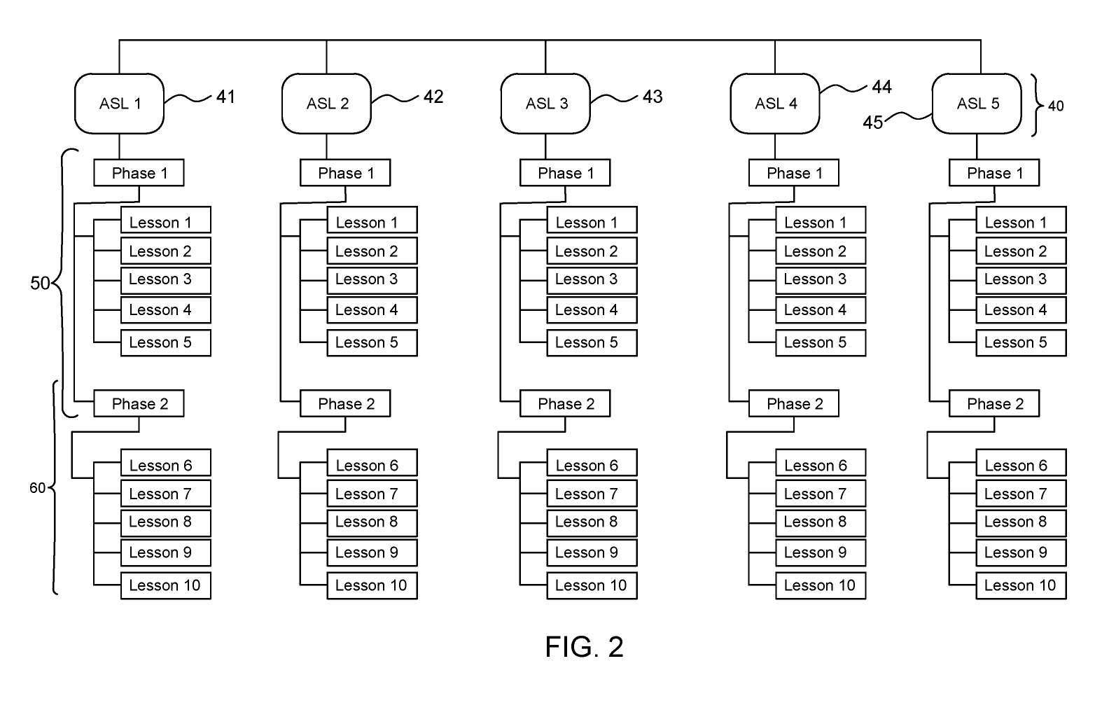

The lessons portal 21 provides access to vocabulary 31a and test and quizzes 31b. These levels designate sub-categories of this particular portal, which have an additional sub levels to allow an individual to engage in specific aspects in terms of vocabulary under the vocabulary 31a option and enables the user to engage in tests quizzes under the test and quizzes 31b option after going through lessons that are available. Lesson portals are shown in FIG. 2 for a series of lessons labeled ASL1 41, ASL2 42, ASL3 43, ASL4 44 and ASL5 45 as lesson engagement portals associated with various lessons. The lessons are sub-divided within a first phase 50 and then a second phase 60. These lessons allow a user to progress through the complexities of American Sign Language. After completion of a group of lessons, tests and quizzes are available through the test & quizzes 31b portal.

The lessons Portal 21 provides the principle learning portal for the user of the system according to the present invention. However other portals include a dictionary portal 22, which that includes a drop menu feature that allows a user to search through various sign symbols and associated language. Gaming Portal 23 includes a series of games that help the user to engage in sign language. A history Portal 24 is provided that provides the history associated with the American Sign Language and the symbols used therein.

Further portals are provided in the system include a news portal 25, which provides news associated with the deaf community. Contacts Portal 26 can be used to gather contacts that may be associated with the learning system or general context that may be associated with the deaf community. Finally, the support portal 27 provides a support entry way to provide help with interactive aspects of the system and reporting problems with the system.

A user may access these portals through a software application residing on a computing system. The computing system may include a desktop, a laptop, tablet or smart phone as all commonly used in modern computing world. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A system to learn American Sign Language comprising:
a plurality of portals accessible through a software application, wherein said plurality of portals enable a user to engage in interactive learning experiences;
a first level of engagement for each portal; and
a second level of engagement for each portal, where each second level provides an interactive platform for the use of the system

2. The system according to claim 1, where the plurality of portals include a lesson portal, a dictionary portal, a gaming portal, a history portal, a news portal, a contact portal and a support portal.

3. The system according to claim 2, wherein the lesson portal includes a vocabulary option, tests and quizzes and a plurality of American Sign Language lessons.

4. The system according to claim 3, wherein the plurality of American Sign Language lessons including a Phase 1 level and a Phase 2 level.

5. The system according to claim 2, wherein the gaming portal includes a plurality of sign language games.
